(19) United States
(12) Patent Application Publication
(10) Pub. No.: US 2016/0372863 A1
(43) Pub. Date: Dec. 22, 2016

(54) ELECTRICAL CONNECTOR ASSEMBLY

(71) Applicant: SPEED TECH CORP., TAOYUAN CITY (TW)

(72) Inventors: James Patrick YOUNG, Taoyuan City (TW); Kuo-Hua HUANG, Taoyuan City (TW)

(21) Appl. No.: 15/092,612

(22) Filed: Apr. 6, 2016

(30) Foreign Application Priority Data
Jun. 17, 2015 (TW) 104209801

(51) Int. Cl. H01R 13/627; H01R 24/66; H01R 24/76; H01R 13/646

(52) U.S. Cl. CPC H01R 13/6272; H01R 13/646; H01R 24/66; H01R 24/76

(57) ABSTRACT

An electrical connector assembly includes a plug connector and a socket connector. The plug connector includes a housing, and the housing has a connection bar and a mounting surface. The connection bar has a button portion, a support portion, a pair of support portions and a joint portion, wherein the pair of support portions are rotatably connected with the mounting surface to form a pivot axis. The button portion and the joint portion are located at two opposite ends of the connection bar to enable the connection bar to be pivoted relative to the mounting surface, and the mounting surface is an outer surface of the housing. The socket connector includes a coupling portion to receive the joint portion of the connection bar.

### RELATED APPLICATIONS

This application claims priority to Taiwanese Application Serial Number 104209801, filed Jun. 17, 2015, which are herein incorporated by reference.

### BACKGROUND

Field of Invention

The present invention relates to an electrical connector assembly, and particularly relates to an electrical connector assembly of a plug connector and a socket connector.

Description of Related Art

Since most electronic devices continue to increase their data transmission amount, the majority of electronic devices also increase their signal transmitting rates in order to provide a more user-friendly experience. In order to allow users to transfer large amounts of electronic data in an even shorter time, the current way is to enhance signal-transmitting frequency between electronic devices in addition to increasing more channels for transmitting electrical signals. However, the high-frequency electrical signals may easily cause cross talks due to a small-volume electronic device trend so as to generate high-frequency noises. Therefore, in this ever-increasing frequency of electronic signals transferring between different electronic devices, the adverse effects of high-frequency electronic signals should be considered in the connector design, and the disadvantages of high frequency signals should be properly controlled to reduce its impact such that high-frequency electrical signals can be properly transferred between electronic devices.

However, another problem is the assembling efficiency between a cable and an electronic device in addition to the cross talks caused by transferring the high-frequency electrical signals. In order to enhance the efficiency of assembling the cable into the electronic device, two opposite ends of the cable should be provided with a corresponding connector associated with the electronic device such that the cable can be rapidly plugged into the electronic device. The connector plays a very important role of not only being able to enhance assembling efficiency between electronic devices but also the quality of the high-frequency signal transmission. How to improve the efficiency of assembling the cable into the electronic device, and maintaining a high-frequency signal transmission quality are the major issues to be solved.

FIG. 1 illustrates a perspective view of a conventional electrical connector disclosed in Taiwanese Patent Serial Number M485551. The conventional electrical connector includes a cable A, a release member B, a circuit board C, a latch D and a housing E. In such disclosure, the cable A is installed into the housing E and electrically connected with the circuit board C. The release member B is assembled to the housing E and is movable along with the latch D. When the electrical connector is interconnected with a counter-part connector, the release member B is exercised along with the latch D to detach the electrical connector from its counter-part connector. However, in such a design, not only increasing in the manufacturing costs but also increasing in the wide variety of parts causes the complex, cumbersome and costly shortcomings of the traditional process, which is not conducive to the automated mass production. Therefore, it is necessary to improve such electrical connector design.

### SUMMARY

An aspect of this invention provides an electrical connector assembly of a plug connector and a socket connector in order to have a simpler design, thereby enhancing assembling efficiency.

According to one or more embodiments of this invention, an electrical connector assembly includes a plug connector and a socket connector. The plug connector includes a housing, and the housing has a connection bar and a mounting surface. The connection bar has a button portion, a support portion, a pair of support portions and a joint portion, wherein the pair of support portions are rotatably connected with the mounting surface to form a pivot axis. The button portion and the joint portion are located at two opposite ends of the connection bar to enable the connection bar to be pivoted relative to the mounting surface, and the mounting surface is an outer surface of the housing. The socket connector includes a coupling portion to receive the joint portion of the connection bar.

According to one or more embodiments of this invention, the housing has a pair of protrusions to be pivotally connected with the pair of support portions.

According to one or more embodiments of this invention, the pair of protrusions are located at two opposite sides of the mounting surface.

According to one or more embodiments of this invention, the joint portion of the connection bar protrudes out of the housing.

According to one or more embodiments of this invention, the connection bar of the plug connector has a resilient arm, which applies a prestressing force upon the mounting surface of the housing, so as to retain a position of the connection bar on the mounting surface.

According to one or more embodiments of this invention, the prestressing force applied upon the mounting surface of the housing forms a torque.

According to one or more embodiments of this invention, the socket connector has a shielding housing, which is made from a bent metal sheet, and the coupling portion is disposed on a surface of the shielding housing.

According to one or more embodiments of this invention, the coupling portion is a through hole, and the joint portion is a hook configured to engage the through hole.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a perspective view of a conventional electrical connector assembly disclosed in Taiwanese Patent Serial Number M485551;

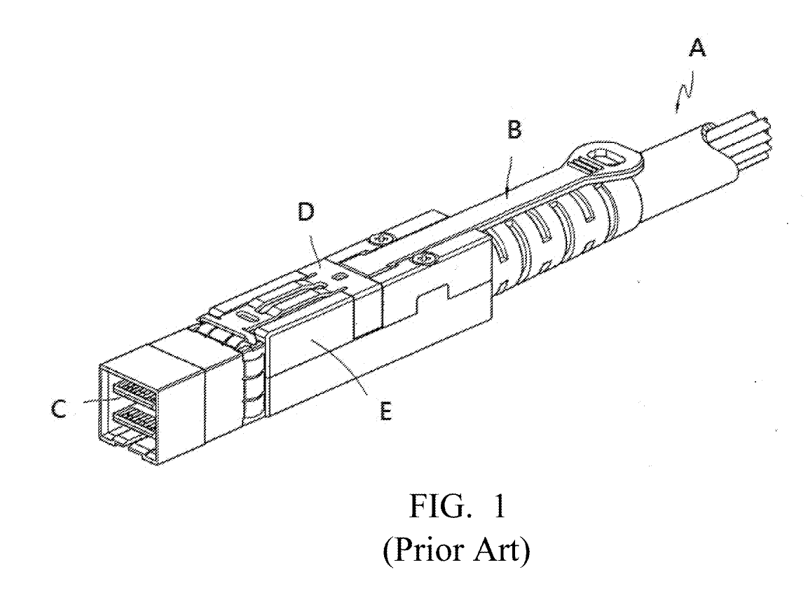

FIG. 2 illustrates a perspective view of an electrical connector assembly according to an embodiment of this invention;

FIG. 3 illustrates an exploded view of the electrical connector assembly in FIG. 2;

FIG. 4 illustrates a perspective view of an electrical connector assembly in two parts according to an embodiment of this invention; and

FIG. 5 illustrates an enlarged view of a connection bar of the electrical connector assembly according to an embodiment of this invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

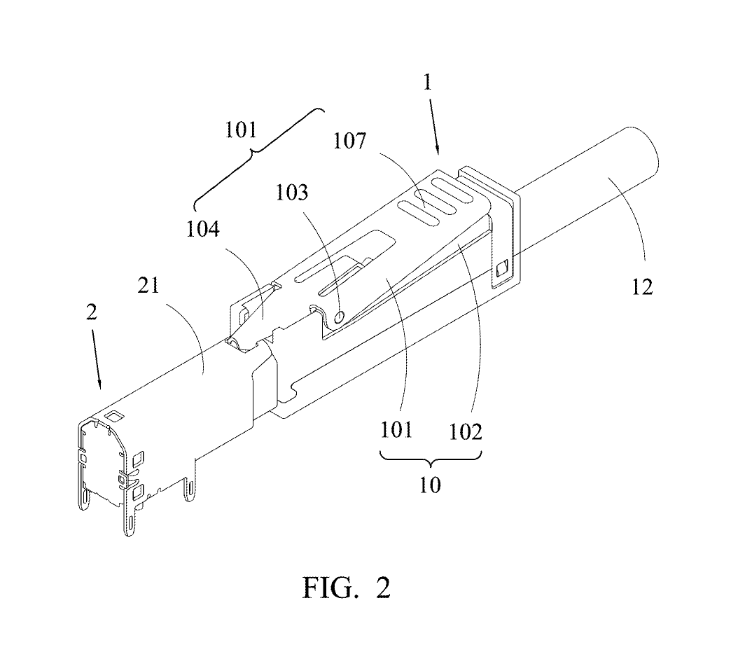

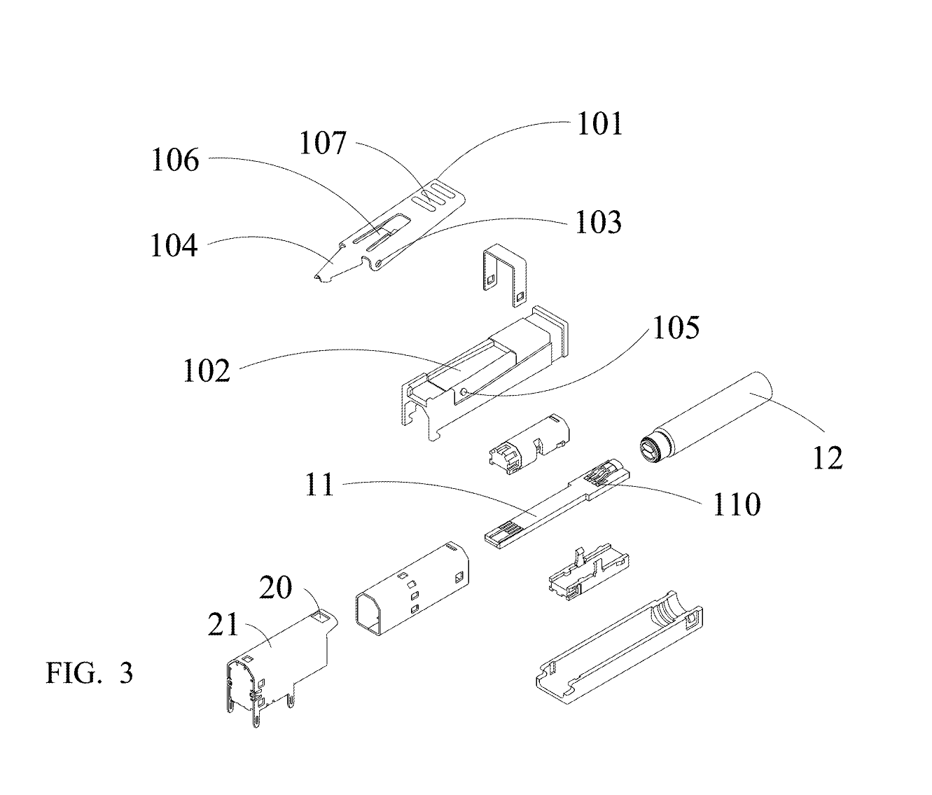

Referring to FIGS. 2-5, which illustrate an electrical connector assembly according to embodiments of this invention. The electrical connector assembly includes a plug connector 1 and a socket connector 2. The plug connector 1 has a housing 10, a signal transmitting module 11 and a cable 12, wherein the housing 10 has a connection bar 101 and a mounting surface 102. In this embodiment, the housing 10 includes an upper part and a lower part, which are made from electrical insulating materials and assembled as a whole piece, but is not limited to such manufacturing way. The mounting surface 102 is an outer surface of the upper part of the housing 10. The connection bar 101 has a button portion 107, a pair of support portions 103 and a joint portion 104, wherein the button portion 107 and the joint portion 104 are located at two opposite ends of connection bar 101, and the joint portion 104 of the connection bar 101 protrudes out of the upper part of the housing 10. The pair of support portions 103 are rotatably connected with the mounting surface 102 of the housing 10 to form a pivot axis for the connection bar 101 such that the connection bar 101 can be pivoted relative to the mounting surface 102, and the button portion 107 can be pressed downwards to lift the joint portion 104 upwards.

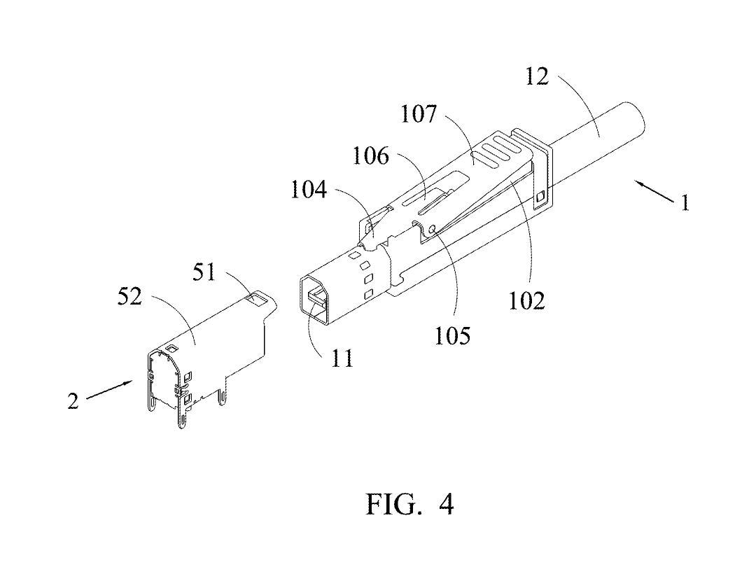

The signal-transmitting module 11 has several electrical terminals 110 and is enclosed within the housing 10 (referring to FIG. 4). In this embodiment, the signal-transmitting module 11 is a printed circuit board, but may be other components of the same function, e.g., other electrical terminal configurations. The cable 12 in this embodiment may include several core wires to be connected with the electrical terminals 110 on the signal-transmitting module 11. When the socket connector 2 and the plug connector 1 are interconnected, signal terminals of the socket connector 2 (not illustrated in drawings) are connected with the signal-transmitting module 11 of the plug connector 1, and further connected with the cable 12. Because the joint portion 104 of the connection bar 101 protrudes out of the upper part of the housing 10 and the pair of support portions 103 are rotatably connected with the mounting surface 102 of the housing 10, a coupling portion 21 of socket connector 2 can receive the joint portion 104 of the connection bar 101 when the socket connector 2 and the plug connector 1 are interconnected. When the plug connector 1 is detached from the socket connector 2, the button portion 107 is pressed downwards to lift the joint portion 104 upwards and away from the coupling portion 20 of the socket connector 2 by using the pair of support portions 103 as the pivot axis.

In particular, a pair of protrusions 105 are located at two opposite sides of the mounting surface 102 of the housing 10 of the plug connector 1, and configured to be pivotally connected with the pair of support portions 103. With this regard, the connection bar 101 is pivotally connected with the housing 10 by means of the protrusions 105 being pivotally connected with the support portions 103. Alternately, protrusions 105 may be replaced with pivot holes (not illustrated in drawings) while the support portions 103 of the connection bar 101 may be pins configured to be inserted into the pivot holes such that the connection bar 101 can also be pivotally connected with the mounting surface 102. The connection bar 101 may further include a resilient arm 106, which applies a prestressing force upon the mounting surface 102 of the housing 10, so as to retain a position of the connection bar 101 on the mounting surface 102. In this embodiment, the resilient arm 106 may be an elastically deformable member, which applies a prestressing force upon the mounting surface 102 of the housing 10, so as to retain the joint portion 104 closer to the signal-transmitting module 11 when the button portion 107 is not pressed manually. In practice, the resilient arm 106 may be other structures of similar functions.

In addition, the socket connector 2 may include a shielding housing 21, which is made from a bent metal sheet, and the coupling portion 20 is located on a surface of the shielding housing 21. In this embodiment, the coupling portion 20 on the shielding housing 21 of the socket connector 2 is a through hole, and the joint portion 104 is a hook configured to engage the through hole. When the socket connector 2 and the plug connector tends to be interconnected, the button portion 107 of the connection bar 101 is pressed downwards against a torque, formed by the prestressing force of the resilient arm 106 applied upon the mounting surface of the housing 10, to lift the joint portion 104 upwards by using the pair of support portions 103 as the pivot axis. With this regard, the joint portion 104 of the connection bar 101 can be latched with the coupling portion 20 of the shielding housing 21 of the socket connector 2 at will.

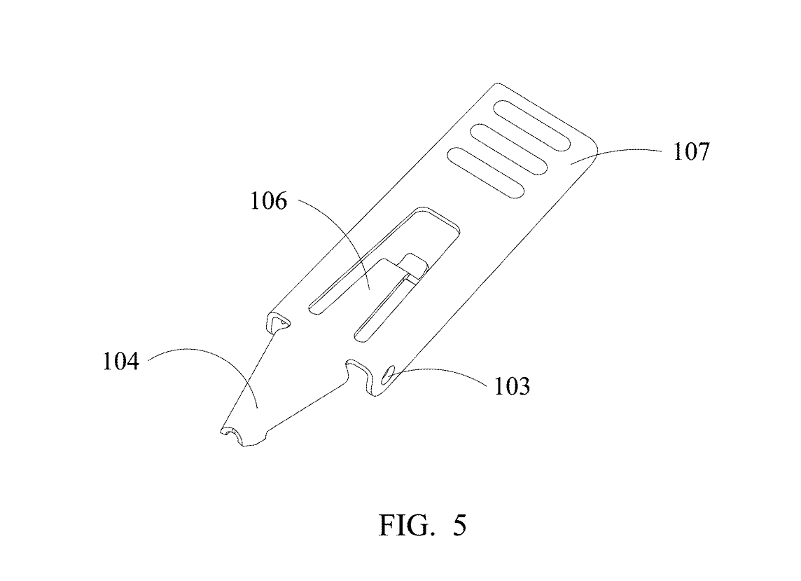

When the plug connector 1 tends to be detached from or interconnected with the socket connector 2, the connection bar 101 is exercised to achieve both two circumstances. As described in preceding paragraphs, the pair of support portions 103 are rotatably connected with the protrusions 105 of the mounting surface 102 of the housing 10 to form a pivot axis for the connection bar 101 such that the connection bar 101 can be pivoted relative to the mounting surface 102, and the resilient arm 106 of the connection bar 101 being bent towards the mounting surface 102 and in contact with the mounting surface 102 (referring to FIG. 5). When the plug connector 1 tends to be interconnected with the socket connector 2, a protruding portion (i.e., protruding out of the housing 10) of the joint portion 104 of the connection bar 101 can be latched with the coupling portion 20 of the shielding housing 21 of the socket connector 2. When the plug connector 1 tends to be detached from the socket connector 2, the connection bar 101 is still exercised to lift the joint portion 104 away from the coupling portion 20 (i.e., by pressing the button portion 107 downwards), the plug connector 1 can be then from the socket connector 2.

Because the shielding housing 21 encloses the socket connector 2, and the shielding housing 21 is made from metallic materials, the shielding housing 21 can isolate EMI cross talks when the plug connector 1 is interconnected with the socket connector 2. Since grounding the high-frequency electromagnetic waves is an effective strategy to suppress electromagnetic noises, the shielding housing 21 is interconnected with the plug connector 1, to form a ground route.

With the electrical connector assembly designed as such, the shielding housing 21 can effectively suppress electromagnetic noises when the signal is transmitted. In addition, the detached mechanism between the connection bar 101 and the coupling portion 20 is designed to be simpler to enhance assembling efficiency such that the assembly process can be easier to increase productivity and improve the complex, cumbersome and costly shortcomings of the traditional process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electrical connector assembly comprising:
a plug connector comprising a housing, the housing having a connection bar and a mounting surface, the connection bar having a button portion, a support portion, a pair of support portions and a joint portion, wherein the pair of support portions are rotatably connected with the mounting surface to form a pivot axis, the button portion and the joint portion are located at two opposite ends of the connection bar to enable the connection bar to be pivoted relative to the mounting surface, and the mounting surface is an outer surface of the housing; and
a socket connector comprising a coupling portion to receive the joint portion of the connection bar.

2. The electrical connector assembly of claim 1, wherein the housing has a pair of protrusions to be pivotally connected with the pair of support portions.

3. The electrical connector assembly of claim 2, wherein the pair of protrusions are disposed at two opposite sides of the mounting surface.

4. The electrical connector assembly of claim 1, wherein the joint portion of the connection bar protrudes out of the housing.

5. The electrical connector assembly of claim 1, wherein the connection bar of the plug connector has a resilient arm, which applies a prestressing force upon the mounting surface of the housing, so as to retain a position of the connection bar on the mounting surface.

6. The electrical connector assembly of claim 5, wherein the prestressing force applied upon the mounting surface of the housing forms a torque.

7. The electrical connector assembly of claim 1, wherein the socket connector has a shielding housing, which is made from a bent metal sheet, and the coupling portion is disposed on a surface of the shielding housing.

8. The electrical connector assembly of claim 7, wherein the coupling portion is a through hole, and the joint portion is a hook configured to engage the through hole.
